(19) United States
(12) Patent Application Publication
(10) Pub. No.: US 2024/0240703 A1
(43) Pub. Date: Jul. 18, 2024

(54) DENTATE STRUCTURE AND METHOD OF USING THE SAME

(71) Applicant: FIVEGRAND INTERNATIONAL CO., LTD., New Taipei City (TW)

(72) Inventor: TING-JUI WANG, New Taipei City (TW)

(21) Appl. No.: 18/404,908

(22) Filed: Jan. 5, 2024

(30) Foreign Application Priority Data
Jan. 13, 2023 (TW) 112101658

(51) Int. Cl. F16H 55/17

(52) U.S. Cl. CPC F16H 55/17

(57) ABSTRACT

A dentate structure and a method of using the dentate structure are introduced. The dentate structure includes a corpus portion and a first dentate portion. The method involves coupling the first dentate portion to the corpus portion such that a fitting portion of the corpus portion is adapted to be fitted to a body, allowing the body to enable the first dentate portion to undergo transmission.

### CROSS-REFERENCE TO RELATED APPLICATION

This non-provisional application claims priority under 35 U.S.C. § 119(a) on Patent Application No(s). 112101658 filed in Taiwan, R.O.C. on Jan. 13, 2023, the entire contents of which are hereby incorporated by reference.

### BACKGROUND OF THE INVENTION

### 1. Field of the Invention

The present disclosure relates to a transmission structure, and in particular to a dentate structure and a method of using the same.

### 2. Description of the Related Art

A gear serving as a transmission component is disposed on every related body to allow transmission to take place between the bodies and thereby enable the displacement thereof. The gears mesh with each other to enable one body to drive the motion or rotation of the other body.

However, methods of using conventional dentate structures have drawbacks. The conventional dentate structures are rarely embodied in parts and components suitable for modularization, for example, precluding the possibility of allowing the same axle to operate in conjunction with gears with different diameters, to the detriment of the flexible applicability of the transmission function of the gears on the bodies. Furthermore, the conventional dentate structures preclude the possibility of the use of axles and gears made of different materials to achieve transmission purposes, leaving little room for improvement in terms of structural reinforcement and cost reduction.

In view of the aforesaid drawbacks of the prior art, it is important to provide improved technology of a dentate structure and a method of using the same.

### BRIEF SUMMARY OF THE INVENTION

To this end, the inventor of the present invention performed related research and devised a method of using a dentate structure to enable a dentate portion to be flexibly applied to a body for transmission purposes.

The first aspect of the disclosure provides a method of using a dentate structure, the dentate structure comprising a corpus portion and a first dentate portion, the method comprising a step of coupling the first dentate portion to the corpus portion to allow a fitting portion of the corpus portion to be adapted to be fitted to a body.

In an embodiment, the fitting portion of the corpus portion has a material-storing space, and the method comprises a step of pressing the corpus portion against the body to allow material of the body to flow into or enter the material-storing space so as to fix the fitting portion to the body.

In an embodiment, the fitting portion is an expanded connection structure, the body has a fitting hole, and the method comprises a step of placing the fitting portion at the fitting hole and pressing the fitting portion against the body to allow the dentate structure to be fixed to the body by the fitting portion through expanded connection.

In an embodiment, the fitting portion is a solderable member, the body has a fitting hole, and the method comprises a step of placing the fitting portion at the fitting hole and heating up solder applied to the fitting portion to fix the corpus portion to the body by soldering.

In an embodiment, the fitting portion comprises a fastening member, and the method comprises a step of fastening the fastening member to the fitting portion so as for the fastening member to be fixedly coupled to the body. Alternatively, the fitting portion comprises an engaging member, and the method comprises a step of providing the engaging member engaged with the fitting portion and thus fixedly coupled to the body. Alternatively, the fitting portion comprises a resilient engaging member, and the method comprises a step of providing the resilient engaging member engaged with the fitting portion and thus fixedly coupled to the body.

In an embodiment, the dentate structure comprises an intervening member conducive to friction reduction, and the method comprises a step of mounting the intervening member in place between the corpus portion and the first dentate portion.

In an embodiment, the corpus portion has a rotation-preventing portion, the method comprises a step of providing the rotation-preventing portion conducive to rotation prevention and position limitation between the dentate structure and the body, or the method comprises a step of providing the rotation-preventing portion for limiting a binding position or direction of the dentate structure relative to the body, or the method comprises a step of providing the rotation-preventing portion for limiting a motion direction of the first dentate portion.

In an embodiment, the body is a metallic piece, plastic piece, printed circuit board, housing, casing, rail, cover, handle, fastener, heat-dissipating body or cabinet.

In an embodiment, the corpus portion has an axle portion and a head portion, with the first dentate portion restrained by the head portion and thus movably coupled to the axle portion, or the corpus portion has the axle portion fixedly coupled to the first dentate portion, the axle portion having a limiting portion outside the first dentate portion, and a seat portion is movably coupled to the axle portion and confined to between the first dentate portion and the limiting portion, or the corpus portion has a bolt portion adapted to be movably coupled to the first dentate portion.

In an embodiment, the axle portion and the head portion are coupled to each other or integrally formed; the axle portion and the limiting portion are coupled to each other or integrally formed; the fitting portion and the corpus portion are coupled to each other or integrally formed.

In an embodiment, the rotation-preventing portion is D-shaped, polygonal, dentate, convex or concave.

In an embodiment, the limiting portion is D-shaped, polygonal, dentate, convex or concave.

In an embodiment, the dentate structure comprises a manipulating portion extended to one side of the first dentate portion, or the method comprises a step of actuating the manipulating portion to drive the first dentate portion rotating.

In an embodiment, the dentate structure further comprises an operating member with a dentate portion adapted to be actuated and thus motion-linked to the first dentate portion, or the second dentate portion moves in a pushing direction to come into contact with the first dentate portion and thus enable linked motion, the linked motion being movement, rotation, relative motion, labor-saving motion, gear motion, rack motion or linear motion, or the dentate structure comprises a manipulating portion extended to one side of the first dentate portion, or the method comprises the step of actuating the manipulating portion to allow the first dentate portion to rotate or allow the first dentate portion to be motion-linked to the second dentate portion to enable movement of the operating member, or the method comprises a step of operating the operating member so as for the second dentate portion to be actuated and thus motion-linked to the first dentate portion, so as to actuate the manipulating portion through rotation of the first dentate portion.

In an embodiment, the linked motion is movement, rotation, relative motion, gear motion, rack motion, labor-saving motion or linear motion.

In an embodiment, the operating member has a second corpus portion, the second corpus portion has a second fitting portion adapted to be fitted to a second body, the second fitting portion has a second material-storing space, the method comprises a step of pressing the second corpus portion against the second body to allow material of the second body to flow into or enter the second material-storing space to fix the second fitting portion to the second body.

In an embodiment, the operating member has a second corpus portion, the second corpus portion has a second fitting portion adapted to be fitted to a second body, the second fitting portion is an expanded connection structure, the second body has a second fitting hole, the method comprises a step of placing the second fitting portion at the second fitting hole and pressing the second fitting portion against the second body to allow the operating member to be fixed to the second body by the second fitting portion through expanded connection.

In an embodiment, the operating member has a second corpus portion, the second corpus portion has a second fitting portion adapted to be fitted to a second body, the second fitting portion is a solderable member, the second body has a second fitting hole, the method comprises a step of heating up solder applied to the second fitting portion to fix the second corpus portion to the second body by soldering.

In an embodiment, the operating member has a second corpus portion, and/or the second corpus portion has a position-limiting portion, or a second body fitted to the second corpus portion has a position-limiting portion, and/or the method comprises a step of providing the position-limiting portion conducive to rotation prevention, positioning or orienting between the corpus portion and the second body, or the operating member has an abutting portion or a second head portion such that the abutting portion or the second head portion abuts against the second corpus portion while the operating member is moving, or the operating member comprises a resilient component, and the method comprises a step of providing the resilient component with one end abutting against the second corpus portion and the other end abutting against the abutting portion to allow the operating member to be normally pushed in a direction toward the second dentate portion, or providing the resilient component with one end abutting against the second corpus portion and the other end abutting against the second head portion to allow the operating member to be normally pushed in a direction away from the second dentate portion.

In an embodiment, the operating member has a second corpus portion such that the second corpus portion and a second body connected to the second corpus portion are fitted together, or the second corpus portion is integrally formed with the second body, wherein the second body is a metallic piece, plastic piece, housing, casing, cabinet, rail, cover, handle, fastener or heat-dissipating body.

In an embodiment, the dentate portion moves in a pushing direction to come into contact with the first dentate portion and thus enable linked motion, the linked motion being movement, rotation, relative motion, labor-saving motion, gear motion, rack motion or linear motion.

In an embodiment, the operating member has a second corpus portion and is bolted to a second head portion, and the method comprises a step of providing the second head portion movable relative to the second corpus portion to an abutting high-position or an abutting low-position to abut against the second corpus portion, or attain positioning upon movement of the operating member.

In an embodiment, the operating member has a second corpus portion and is bolted to a second head portion, and the method comprises a step of providing the second head portion movable relative to the second corpus portion to an abutting high-position or an abutting low-position to abut against the second corpus portion, or resist a resilience force of a resilient component to attain positioning upon movement of the operating member.

In an embodiment, the operating member has a second corpus portion, the second corpus portion or the operating member has a second limiting portion, the method comprises a step of providing the second limiting portion conducive to rotation prevention, positioning or orienting between the operating member and the second corpus portion.

In an embodiment, the dentate structure comprises a manipulating portion extended to one side of the first dentate portion, and the method comprises the step of actuating the manipulating portion to allow the first dentate portion to rotate or allow the first dentate portion to be motion-linked to the second dentate portion to enable movement of the operating member, or the method comprises a step of operating the operating member so as for the second dentate portion to be actuated and thus motion-linked to the first dentate portion, so as to actuate the manipulating portion through rotation of the first dentate portion. In an embodiment, the body has teeth, and the method comprises a step of allowing the teeth to come into contact with the dentate structure so as for the dentate structure to drive the body undergoing movement, relative motion or motion, or the method comprises a step of allowing the dentate structure to come into contact with the teeth so as for the dentate structure in contact with a second dentate portion to undergo motion and thus drive the body undergoing movement, relative motion, motion, rotation or labor-saving motion.

In an embodiment, the dentate structure has two first dentate portions, one of which undergoes motion together with or comes into contact with a dentate structure, or the two dentate portions undergo motion together with or come into contact with two dentate structures.

In an embodiment, the teeth or the dentate structure is a rack, gear or threaded body.

In an embodiment, the dentate structure comprises an operating member, or the first dentate portion is disposed at the body through the corpus portion, or the method comprises a step of configuring the first dentate portion as teeth in contact with a second body, or the first dentate portion comes into contact with a second dentate portion of the operating member, or a circuit is connected between the first dentate portion, the operating member or the second body, or the circuit is in communication connection with an electronic apparatus via wireless or wired signals, or a finger moves the operating member to enable the first dentate portion, the operating member or the second body to transmit motion to control the electronic apparatus. Alternatively, an instruction is inputted with the electronic apparatus to use wireless or wired signals to controllably cause the first dentate portion to rotate or controllably causes the operating member to move, so as to drive the second body undergoing movement, relative motion or motion, and/or the body has a fixing element, and/or the fixing element comprises a head portion and a neck portion, and/or the operating member is movably disposed at the neck portion, and/or the operating member is restrained by the head portion.

In an embodiment, the dentate structure comprises an operating member, or the operating member is movably disposed at the body, and the method comprises a step of connecting the first dentate portion and the operating member by a circuit therebetween, or the circuit is in communication connection with an electronic apparatus via wireless or wired signals, so as to control the electronic apparatus through the rotation of the first dentate portion. Alternatively, an instruction is inputted with the electronic apparatus to control the first dentate portion or controllably cause the operating member to undergo movement, relative motion or motion.

In an embodiment, the dentate structure comprises two first dentate portions, or one of the two first dentate portions is a threaded body, or the first dentate portion is adapted to come into contact with the dentate structure to allow the first dentate portion and the dentate structure in contact with the first dentate portion to undergo movement, relative motion or motion, or the first dentate portion has a post whose motion is caused by the motion of the first dentate portion and another dentate structure, or the post undergoes motion to drive the first dentate portion and another dentate structure undergoing motion, or the first dentate portions of at least two said dentate structures are connected by a connection component and adapted to be driven, moved, jointly moved or linked, or the dentate structure has an engaging portion adapted to be driven, moved, jointly moved or linked; or the dentate structure has an engaging portion for use in fastening or for being fastened to another body.

In an embodiment, the connection component is a link, track, strip-shaped piece, belt, metallic band, non-metallic band, dentate body or chain.

In an embodiment, the engaging portion is a threaded body, outer fastener, inner fastener, resilient fastener or post.

In an embodiment, the dentate structure has an operating member for controllably operating or moving the engaging portion.

In an embodiment, the corpus portion and the body are integrally formed, or the fitting portion and the body are integrally formed.

The second aspect of the disclosure provides a dentate structure comprising a corpus portion and a first dentate portion, with the first dentate portion coupled to the corpus portion, such that a fitting portion of the corpus portion is adapted to be fitted to a body.

Therefore, according to the disclosure, a dentate structure and a method of using the same are effective in allowing a first dentate portion to be rotatably coupled to a corpus portion and allowing a fitting portion of the corpus portion to be fitted to a body, so as to enable the first dentate portion to be flexibly applied to the body for transmission purposes.

### BRIEF DESCRIPTION OF THE DRAWINGS

FIG. 1 is a schematic view of a dentate structure and a method of using the dentate structure according to the first embodiment of the disclosure.

FIG. 2 is a top view of a first dentate portion of FIG. 1.

FIG. 3 is a schematic view of a dentate structure and a method of using the dentate structure according to the second embodiment of the disclosure.

FIG. 4 is a schematic view of a dentate structure and a method of using the dentate structure according to the third embodiment of the disclosure.

FIG. 5A is a schematic view of a dentate structure and a method of using the dentate structure according to the fourth embodiment of the disclosure.

FIG. 5B is a schematic view of a body and rotation prevention according to the fourth embodiment of the disclosure.

FIG. 6 is a schematic view of a dentate structure and a method of using the dentate structure according to the fifth embodiment of the disclosure.

FIG. 7 is a schematic view of another dentate structure and a method of using the dentate structure according to the first embodiment of the disclosure.

FIG. 8 is a schematic view of yet another dentate structure and a method of using the dentate structure according to the first embodiment of the disclosure.

FIG. 9 is a schematic view of an intervening member disposed between the first dentate portion and a corpus portion according to each embodiment of the disclosure.

FIG. 10 is a schematic view of the dentate structure according to the sixth embodiment of the disclosure.

FIG. 11A is a schematic view of a limiting portion according to any one of the embodiments of the disclosure.

FIG. 11B is a schematic view of another limiting portion and the position-limiting portion according to any one of the embodiments of the disclosure.

FIG. 12 is a schematic view of a method of using the dentate structure according to the sixth embodiment of the disclosure.

FIG. 13 is a schematic view of a method of using the dentate structure in a pushing direction according to the sixth embodiment of the disclosure.

FIG. 14 is a schematic view of a method of using the dentate structure in a pulling direction according to the sixth embodiment of the disclosure.

FIG. 15 is a schematic view of the dentate structure and a method of using the dentate structure according to the seventh embodiment of the disclosure.

FIG. 16 is another schematic view of the dentate structure and a method of using the dentate structure according to the seventh embodiment of the disclosure.

FIG. 17 is a schematic view of the dentate structure and a method of using the dentate structure according to the eighth embodiment of the disclosure.

FIG. 18 is a schematic view of the dentate structure and a method of using the dentate structure according to the ninth embodiment of the disclosure.

FIG. 19 is a schematic view of the dentate structure and a method of using the dentate structure according to the tenth embodiment of the disclosure.

FIG. 20 is a lateral view of FIG. 19.

FIG. 21 is a schematic view of the dentate structure and a method of using the dentate structure according to the eleventh embodiment of the disclosure.

FIG. 22 is a schematic view of a dentate structure and a method of using the dentate structure according to the twelfth embodiment of the disclosure.

FIG. 23 is a schematic view of the dentate structure and a method of using the dentate structure according to the thirteenth embodiment of the disclosure.

FIG. 24 is a lateral view of the dentate structure of FIG. 23.

FIG. 25 shows schematic views of an engaging portion in different forms according to the disclosure.

### DETAILED DESCRIPTION OF THE INVENTION

To facilitate understanding of the object, characteristics and effects of this present disclosure, embodiments together with the attached drawings for the detailed description of the present disclosure are provided.

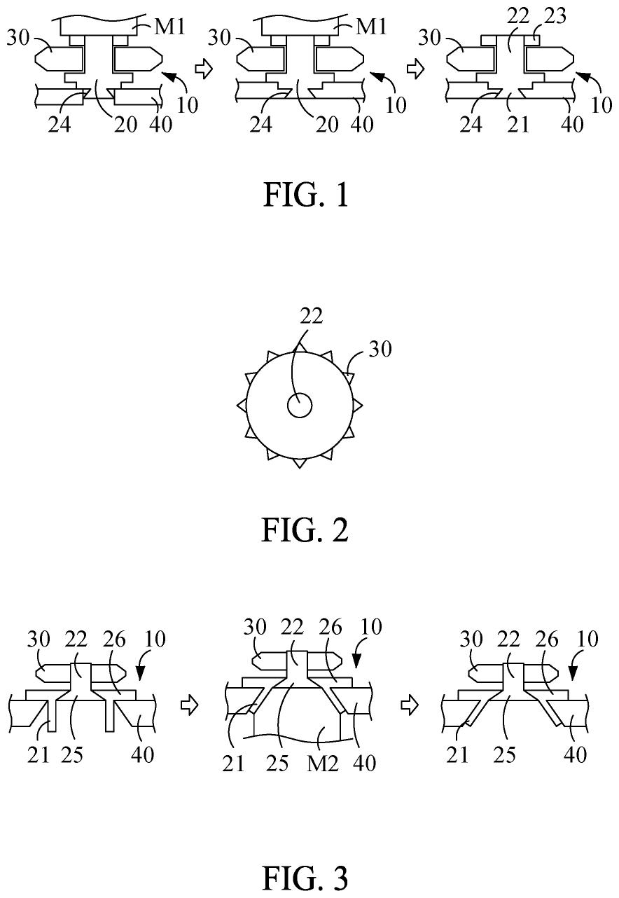

Referring to FIG. 1 through FIG. 25, the first aspect of the disclosure provides a method of using a dentate structure 10. The dentate structure 10 comprises a corpus portion 20 and a first dentate portion. The first dentate portion is hereinafter exemplified by a gear 30. The method comprises the step of allowing the gear 30 to be coupled to the corpus portion 20, for example, allowing the gear 30 to be rotatably coupled to the corpus portion 20, and allowing a fitting portion 21 of the corpus portion 20 to be fitted to a body 40. The body 40 is a metallic piece, plastic piece, printed circuit board, housing, casing, rail, cover, handle, fastener, heat-dissipating body or cabinet. The fitting portion 21 of the corpus portion 20 is fitted to a body 40 integrally formed with the corpus portion 20. Alternatively, the fitting portion 21 and the body 40 are integrally formed, and the corpus portion 20 is fitted to the fitting portion 21.

As shown in FIGS. 1 and 2, in the first embodiment of the disclosure, the corpus portion 20 has an axle portion 22 and a head portion 23. The gear 30 is restrained by the head portion 23 and thus movably coupled to the axle portion 22. In an embodiment, the fitting portion 21 of the corpus portion 20 has a material-storing space 24, and the method comprises the step of pressing the corpus portion 20 against the body 40 to allow the material of the body 40 to flow into or enter the material-storing space 24, thereby fixing the fitting portion 21 to the body 40.

In the first embodiment, the fitting portion 21 is integrally formed with the corpus portion 20, but the disclosure is not limited thereto; for example, the fitting portion 21 and the corpus portion 20 are two separate elements coupled to each other. In the first embodiment, the axle portion 22 and the head portion 23 are two separate elements coupled to each other, but the disclosure is not limited thereto; for example, the axle portion 22 and the head portion 23 are integrally formed.

The use of the dentate structure 10 of the first embodiment entails placing the fitting portion 21 at a fitting hole 41 of the body 40, allowing the corpus portion 20 to abut against the body 40, and allowing, as shown in FIG. 1, for example, a mold M1 to press the head portion 23 of the corpus portion 20 against the body 40 such that the material of the body 40 undergoes deformation at a point corresponding in position to the material-storing space 24 and then flows into or enters the material-storing space 24, allowing the fitting portion 21 of the corpus portion 20 to be fixed to the body 40.

As shown in FIG. 7, technical features distinguishing another aspect of this embodiment from the first embodiment of the disclosure are as follows: the axle portion 22 and the head portion 23 are integrally formed, with the axle portion 22 fixed to the gear 30; the axle portion 22 is movably disposed at the corpus portion 20; the mold M1 presses the corpus portion 20 against the body 40 such that the material of the body 40 undergoes deformation at a point corresponding in position to the material-storing space 24 and then flows into or enters the material-storing space 24, allowing the fitting portion 21 of the corpus portion 20 to be fixed to the body 40. As shown in FIG. 8, technical features distinguishing another aspect of this embodiment from the first embodiment of the disclosure are as follows: the axle portion 22 is movably disposed at the corpus portion 20; the mold M1 presses the fitting portion 21 against the body 40 such that the material of the body 40 undergoes deformation at a point corresponding in position to the material-storing space 24 and then flows into or enters the material-storing space 24, allowing the fitting portion 21 of the corpus portion 20 to be fixed to the body 40.

As described in the first embodiment, the gear 30 is rotatably coupled to the corpus portion 20. The fitting portion 21 of the corpus portion 20 is fitted to the body 40 such that the same corpus portion 20 is applicable to the gears 30 with different diameters, allowing the transmission on the gears 30 to be flexibly applicable to the body 40. The gear 30 is rotatably coupled to the corpus portion 20, and thus the corpus portion 20 and the gear 30 are made of different materials to not only couple the corpus portion 20 and the gear 30 together but also attain structural reinforcement, reduce cost, and greatly improve the manufacturing process.

The method of using a dentate structure of the disclosure can also be implemented in some other aspects of embodiment. As shown in FIG. 3, technical features distinguishing the second embodiment of the disclosure from the first embodiment of the disclosure are as follows: the axle portion 22 of the corpus portion 20 is fixedly coupled to the gear 30; the axle portion 22 has a limiting portion 25 disposed outside the gear 30; a seat portion 26 is movably coupled to the axle portion 22 and confined to between the gear 30 and the limiting portion 25, allowing the gear 30 to be rotatably coupled to the corpus portion 20.

In the second embodiment, the fitting portion 21 is an expanded connection structure, and the method comprises the step of placing the fitting portion 21 at the fitting hole 41 and allowing, for example, a mold M2 to press the fitting portion 21 against the body 40 to allow the dentate structure 10 to be fixed to the body 40 by the fitting portion 21 through expanded connection, thereby allowing the fitting portion 21 of the corpus portion 20 to be fitted to the body 40. Therefore, the second embodiment is as effective as the first embodiment in achieving the objective of the disclosure.

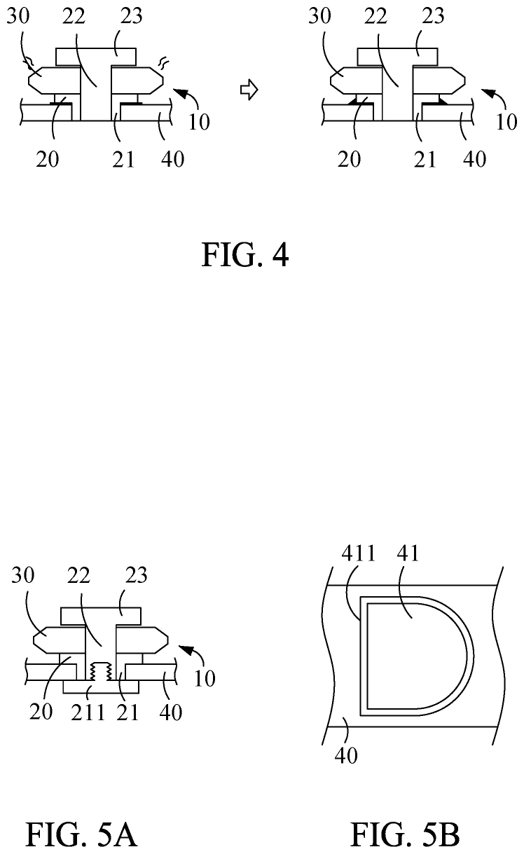

As shown in FIG. 4, technical features provided in the third embodiment of the disclosure and distinguishing the third embodiment from the first embodiment of the disclosure are as follows: the fitting portion 21 is a solderable member, with the body 40 having a fitting hole 41; the method comprises the step of placing the fitting portion 21 at the fitting hole 41 and heating up solder applied to the fitting portion 21 to fix the corpus portion 20 to the body 40 by soldering; the axle portion 22 and the head portion 23 are integrally formed; the fitting portion 21 and the corpus portion 20 are two separate elements coupled to each other. Therefore, the third embodiment is as effective as the first embodiment in achieving the objective of the disclosure.

As shown in FIG. 5A, technical features provided in the fourth embodiment of the disclosure and distinguishing the fourth embodiment from the first embodiment of the disclosure are as follows: the fitting portion 21 comprises a fastening member 211; and the method comprises the step of fastening the fastening member 211 to the fitting portion 21 so as for the fastening member 211 to be fixedly coupled to the body 40. In this embodiment, the fitting portion 21 is either the fastening member 211 or an engaging member (not shown in the diagram), and the method comprises the step of allowing the engaging member to be engaged with the fitting portion 21 and thus fixedly coupled to the body 40. Alternatively, the fitting portion 21 is a resilient engaging member (not shown in the diagram), and the method comprises the step of allowing the resilient engaging member to be engaged with the fitting portion 21 and thus fixedly coupled to the body 40. Therefore, the fourth embodiment is as effective as the first embodiment in achieving the objective of the disclosure.

In the fourth embodiment, the corpus portion 20 has a rotation-preventing portion 411, and the method comprises the step of providing a rotation-preventing portion 411 conducive to rotation prevention and position limitation between the dentate structure 10 and the body 40. Alternatively, the method comprises the step of providing the rotation-preventing portion 411 for limiting the binding position or direction of the dentate structure 10 relative to the body 40. Alternatively, the method comprises the step of providing the rotation-preventing portion 411 for limiting the direction in which the gear 30 undergoes motion. In the first embodiment, the rotation-preventing portion 411 is D-shaped fitting hole 41 (as shown in FIG. 5B), but the disclosure is not limited thereto; for example, the rotation-preventing portion 411 is polygonal, dentate, concave or convex.

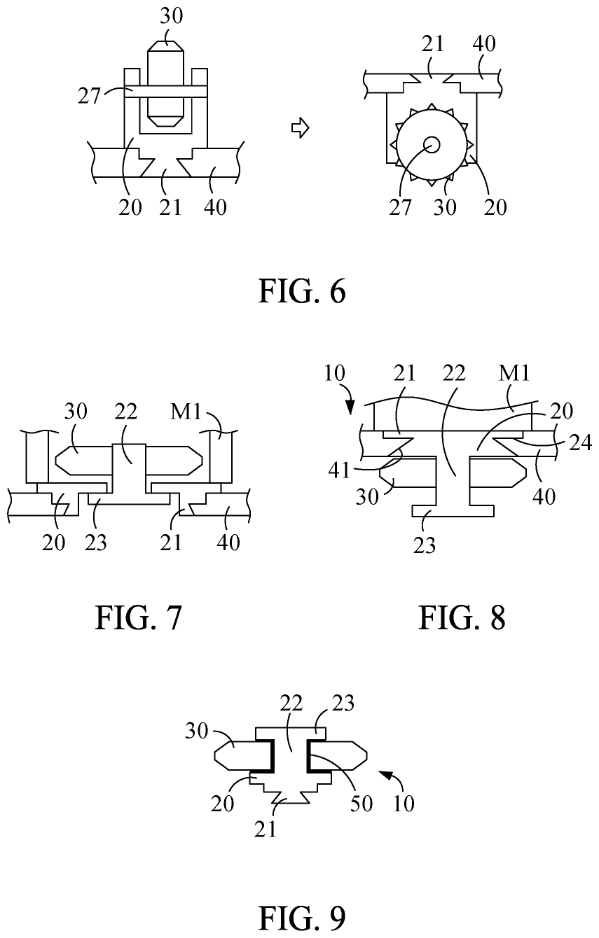

As shown in FIG. 6, technical features provided in the fifth embodiment of the disclosure and distinguishing the fifth embodiment from the first embodiment of the disclosure are as follows: the corpus portion 20 has a bolt portion 27 adapted to be movably coupled to the gear 30. Specifically speaking, the bolt portion 27 is an axle element penetratingly disposed at the corpus portion 20. The use of the dentate structure 10 begins with placing the gear 30 at a predetermined position of the corpus portion 20, allowing the bolt portion 27 to be penetratingly disposed at the corpus portion 20 and the gear 30, and allowing the bolt portion 27 to be rotatably coupled to the corpus portion 20. Therefore, the fifth embodiment is as effective as the first embodiment in achieving the objective of the disclosure.

In the first, third, fourth and fifth embodiments, the dentate structure 10 further comprises an intervening member 50 (as shown in FIG. 9) conducive to friction reduction, and the method comprises the step of mounting the intervening member 50 in place between the corpus portion 20 and the gear 30 to use the intervening member 50 to reduce the friction between the gear 30 in rotation and the corpus portion 20.

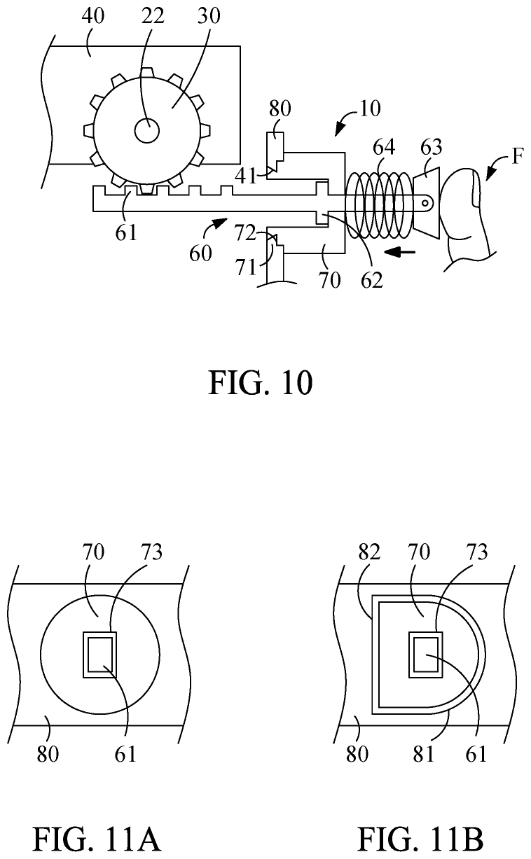

As shown in FIG. 10, the dentate structure 10 in the sixth embodiment of the disclosure not only comprises the corpus portion 20 recited in the first through fifth embodiments and rotatably coupled to the gear 30 but also comprises an operating member 60. The operating member 60 has a second corpus portion 70 and a second dentate portion 61. The method comprises the step of movably fitting the second corpus portion 70 and the operating member 60 together or fitting the second corpus portion 70 and the operating member 60 together, so as for the second dentate portion 61 to be actuated and thus motion-linked to the gear 30.

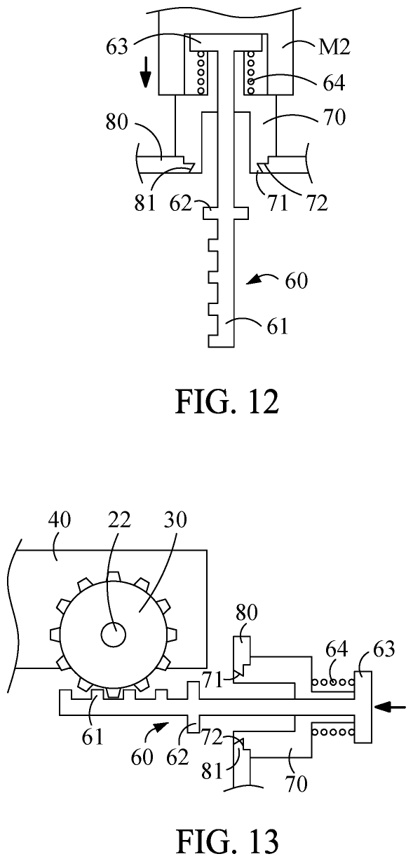

In the sixth embodiment, the operating member 60 has an abutting portion 62 and a second head portion 63. The abutting portion 62 and the second head portion 63 abut against the second corpus portion 70 while the operating member 60 is moving. In a variant embodiment, the operating member 60 has the abutting portion 62 instead of the second head portion 63, and the abutting portion 62 abuts against the second corpus portion 70 while the operating member 60 is moving. In another variant embodiment, the operating member 60 has the second head portion 63 instead of the abutting portion 62, and the second head portion 63 abuts against the second corpus portion 70 while the operating member 60 is moving. As shown in FIG. 12, the second corpus portion 70 has a second fitting portion 71 adapted to be fitted to a second body 80, and the second fitting portion 71 has a second material-storing space 72, wherein the method comprises the step of pressing the second corpus portion 70 against the second body 80 to allow the material of the second body 80 to flow into or enter the second material-storing space 72 to not only fix the second fitting portion 71 in place but also fix the second fitting portion 71 to the second body 80. The second corpus portion 70 and the second body 80 connected to the second corpus portion 70 are two separate elements fitted to each other. Alternatively, the second corpus portion 70 is integrally formed with the second body 80. The second body 80 is a metallic piece, plastic piece, housing, casing, cabinet, rail, cover, handle, fastener or heat-dissipating body.

In the sixth embodiment, the operating member 60 and the second head portion 63 are two separate elements bolted to each other and thus coupled together, but the disclosure is not limited thereto; for example, in this embodiment, the operating member 60 and the second head portion 63 are integrally formed. The second corpus portion 70 has a second limiting portion 73, and the method comprises the step of providing the second limiting portion 73 conducive to rotation prevention, positioning or orienting between the operating member 60 and the second corpus portion 70. In the sixth embodiment, the second limiting portion 73 is quadrilateral in shape (as shown in FIG. 11A), but the disclosure is not limited thereto; for example, the second limiting portion 73 is D-shaped, dentate, concave or convex.

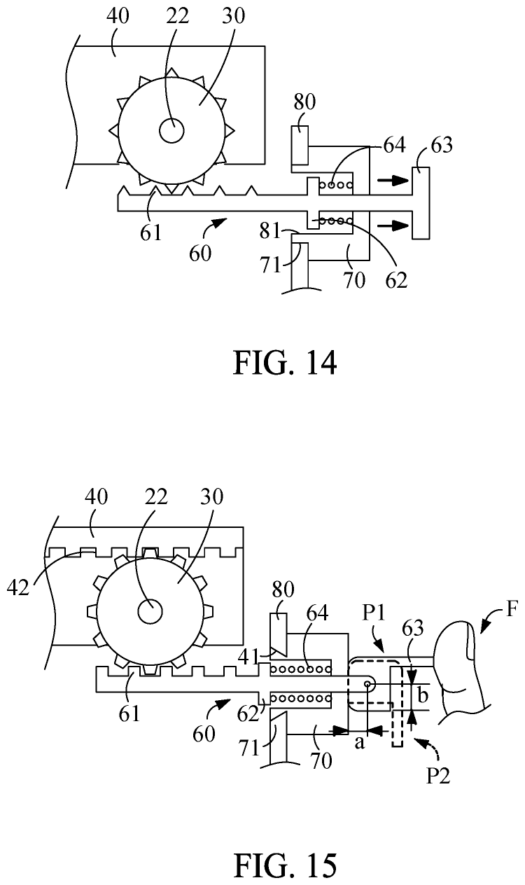

In the sixth embodiment, the operating member 60 comprises a resilient component 64, and the method comprises the step of providing the resilient component 64 with one end abutting against the second corpus portion 70 from outside and the other end abutting against the second head portion 63, allowing the operating member 60 to be normally pushed in a direction away from the second dentate portion 61; meanwhile, a finger F presses on the second head portion 63 to drive the displacement of the operating member 60 such that the second dentate portion 61 drives the rotation of the gear 30. The second dentate portion 61 moves in a pushing direction to come into contact with the gear 30 and thus enable linked motion (as shown in FIG. 13). Alternatively, the second dentate portion 61 moves in a pulling direction to come into contact with the gear 30 and thus enable linked motion (as shown in FIG. 14). In this embodiment, the linked motion is rotation, but the disclosure is not limited thereto; for example, the linked motion is motion, such as relative motion, gear motion, rack motion, labor-saving motion or linear motion.

As revealed by the description of the sixth embodiment, the method of using the dentate structure of the disclosure further comprises the step of providing the operating member 60 operating in conjunction with the gear 30 of the first through fifth embodiments to broaden the application of the dentate structure 10 of the disclosure.

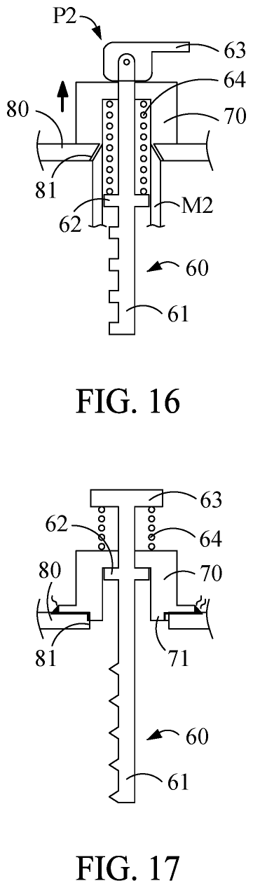

As shown in FIG. 15, technical features provided in the seventh embodiment of the disclosure and distinguishing the seventh embodiment from the sixth embodiment of the disclosure are as follows: the operating member 60 and the second head portion 63 are two separate elements coupled to each other by bolting. A first distance a and a second distance b are defined between the bolting point of the second head portion 63 and the second body 80. The method comprises the step of allowing the second head portion 63 to be, relative to the second corpus portion 70, movable to an abutting high-position P1 to abut against the second corpus portion 70 (as shown in FIG. 15) or to an abutting low-position P2 to abut against the second corpus portion 70 (as shown in FIG. 16), attaining positioning upon completion of the movement of the operating member 60.

The seventh embodiment provides the resilient component 64, and the method comprises the step of providing the resilient component 64 with one end abutting against the second corpus portion 70 from inside and the other end abutting against the abutting portion 62 to allow the operating member 60 to be normally pushed in a direction toward the second dentate portion 61. After moving to the abutting high-position P1 or the abutting low-position P2, the operating member 60 has to resist the resilience force of the resilient component 64, attaining positioning upon completion of the movement of the operating member 60.

In the seventh embodiment, the second fitting portion 71 is an expanded connection structure, the second body 80 has a second fitting hole 81, and the method comprises the step of placing the second fitting portion 71 at the second fitting hole 81 and pressing the second fitting portion 71 against the second body 80 to allow the operating member 60 to be fixed to the second body 80 by the second fitting portion 71 through expanded connection.

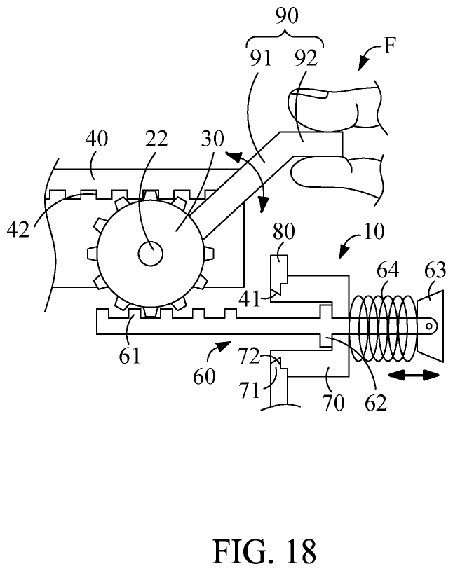

As shown in FIGS. 15 and 18, the gear 30 of the dentate structure 10 is in contact with teeth 42 of the body 40 such that the gear 30 undergoes motion by being in contact with the second dentate portion 61, so as to drive the body 40 undergoing movement, relative motion, motion, rotation or labor-saving motion. The teeth 42 and the second dentate portion 61 can be racks, gears or threaded bodies. The body 40 and the teeth 42 are integrally formed. Alternatively, the body 40 and the teeth 42 are coupled to each other. However, the disclosure is not limited thereto; for example, the body 40 having the teeth 42 adapted to come into contact with the dentate structure 10 so as for the dentate structure 10 to drive the body 40 undergoing movement, relative motion or motion shall be deemed falling within the scope of the claims of the disclosure.

As shown in FIG. 17, technical features provided in the eighth embodiment of the disclosure and distinguishing the eighth embodiment from the sixth embodiment of the disclosure are as follows: the second fitting portion 71 is a solderable member, the second body 80 also has the second fitting hole 81, and the method comprises the step of providing the second fitting portion 71 disposed at the second fitting hole 81 and heating up solder applied to the second fitting portion 71 to fix the second corpus portion 70 to the second body 80 by soldering.

In the sixth, seventh and eighth embodiments, the second corpus portion 70 is fixed to the second body 80. For example, in the sixth embodiment, the material of the second body 80 flows into or enters the second material-storing space 72 such that the second corpus portion 70 is fixed to the second body 80. Alternatively, in the seventh embodiment, the second corpus portion 70 is fixed to the second body 80 through expanded connection. Alternatively, in the eighth embodiment, the second corpus portion 70 is fixed to the second body 80 by soldering. In a variant embodiment, as shown in FIG. 11B, the second body 80 has a position-limiting portion 82, and the method comprises the step of providing the position-limiting portion 82 conducive to rotation prevention, positioning or orienting between the second corpus portion 70 and the second body 80. The position-limiting portion 82 is D-shaped, but the disclosure is not limited thereto; for example, the position-limiting portion 82 is also polygonal, dentate, concave or convex. The position-limiting portion 82 is not necessarily disposed at the second body 80; for example, the position-limiting portion 82 (not shown in the diagram) is disposed at the second corpus portion 70.

As shown in FIG. 18, technical features provided in the ninth embodiment of the disclosure and distinguishing the ninth embodiment from the sixth embodiment of the disclosure are as follows: the dentate structure 10 comprises a manipulating portion 90 extended to one side of the gear 30; the manipulating portion 90 has an extending segment 91, and the terminating end of the extending segment 91 has a turning segment 92; an included angle is defined between the turning segment 92 and the extending segment 91; the method comprises the step of actuating the manipulating portion 90 to allow the turning segment 92 to be turned to enable the gear 30 to rotate through the extending segment 91 and thus become motion-linked to the second dentate portion 61, as shown in FIG. 18, allowing the operating member 60 to undergo motion, for example, linear motion, relative to the second corpus portion 70. Alternatively, the operating member 60 is operated to not only allow the second dentate portion 61 to be actuated to drive the rotation of the gear 30 but also allow the manipulating portion 90 to be actuated, for example, to swing, because of the rotation of the gear 30. Therefore, the dentate structure 10 of the disclosure demonstrates excellence in practical operation.

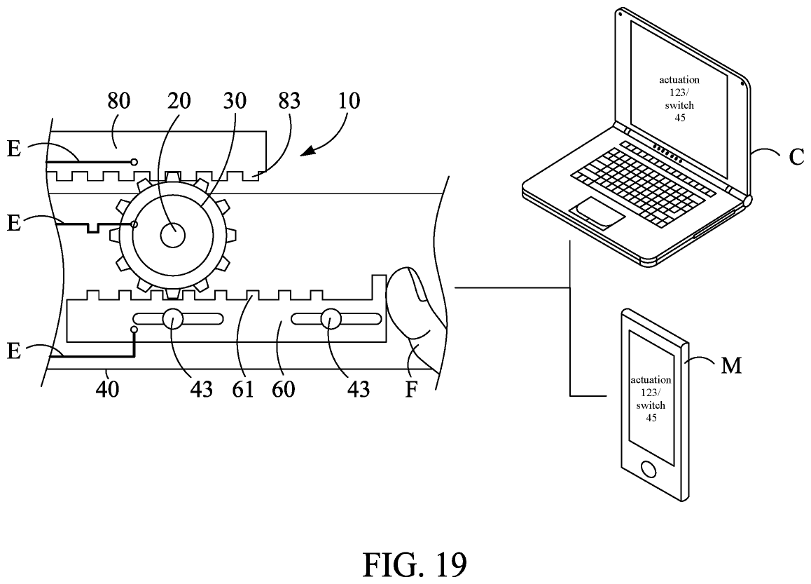

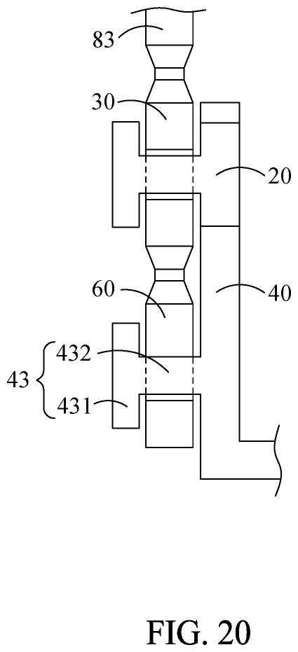

As shown in FIGS. 19 and 20, in the tenth embodiment of the disclosure, the dentate structure 10 comprises a corpus portion 20, a gear 30 and an operating member 60. The gear 30 is disposed at, for example, pivotally connected to, the body 40 through the corpus portion 20. The body 40 has a fixing element 43. The fixing element 43 comprises a head portion 431 and a neck portion 432. The operating member 60 is movably disposed at the neck portion 432 and restrained by the head portion 431 (as shown in FIG. 20). The method comprises the step of configuring the gear 30 as teeth 83 in contact with the second body 80. The gear 30 is in contact with the second dentate portion 61 of the operating member 60 and is connected between the gear 30, the operating member 60 and the second body 80 by a circuit E, and the circuit E is in communication connection with an electronic apparatus (for example, a computer C or a mobile phone M) via wireless or wired signals. The finger F moves the operating member 60 to enable the gear 30, the operating member 60 and the second body 80 to transmit motion to remotely control the switch of the circuit E and the magnitude of the passing electric current and control the electronic apparatus. Alternatively, an instruction (such as actuation instruction “123” and switch instruction “45” shown in the diagrams) is inputted with the electronic apparatus to use wireless or wired signals to controllably cause the gear 30 to rotate or controllably cause the operating member 60 to move, driving the second body 80 to undergo movement, relative motion or motion. Therefore, the dentate structure 10 of the disclosure demonstrates excellence in practical operation.

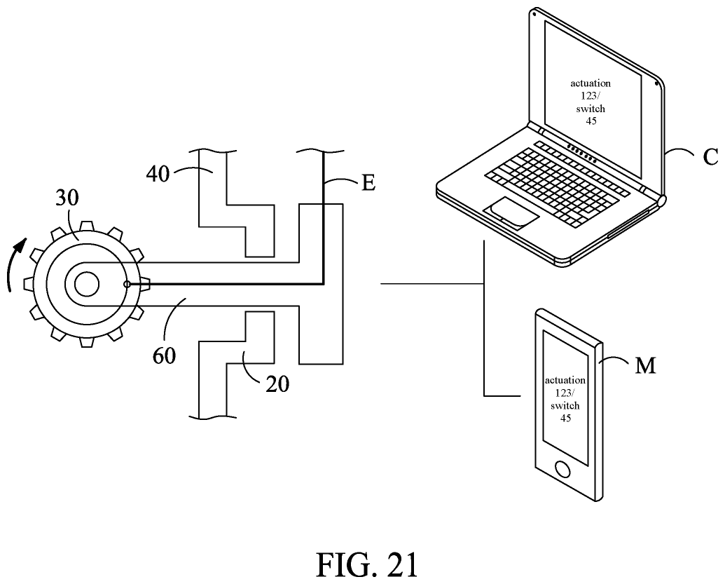

As shown in FIG. 21, in the eleventh embodiment of the disclosure, the dentate structure 10 comprises a corpus portion 20, a gear 30 and an operating member 60. The corpus portion 20 and the body 40 are integrally formed. The operating member 60 is movably disposed at the body 40. The method comprises the step of connecting the gear 30 and the operating member 60 by a circuit E, with the circuit E being in communication connection with an electronic apparatus (for example, a computer C or a mobile phone M) via wireless or wired signals to enable the gear 30 to rotate and thus control the switch of the circuit E and the magnitude of the passing electric current, so as to control the electronic apparatus. Alternatively, an instruction is inputted with the electronic apparatus to control the gear 30 or controllably cause the operating member 60 to undergo movement, relative motion or motion. Therefore, the dentate structure 10 of the disclosure demonstrates excellence in practical operation.

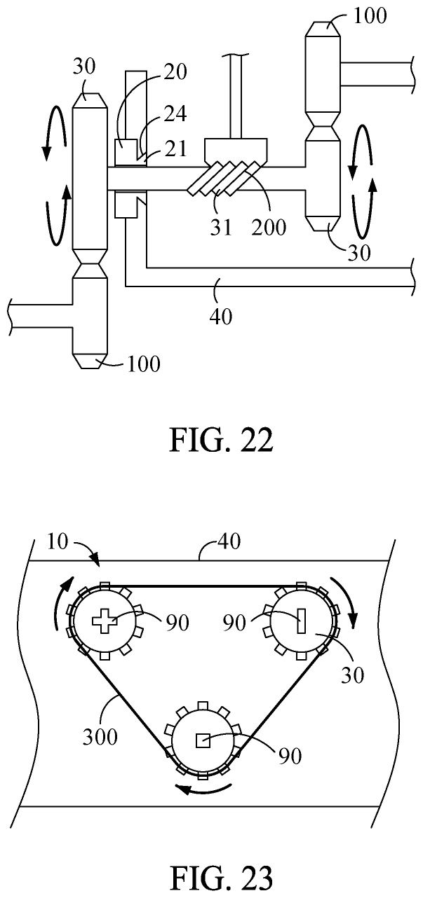

As shown in FIG. 22, in the twelfth embodiment of the disclosure, the dentate structure 10 comprises a corpus portion 20 and two gears 30. The fitting portion 21 of the corpus portion 20 has a material-storing space 24. The two gears 30 are connected by a post 31 therebetween. The post 31 has a threaded body 32. The method comprises the step of pressing the corpus portion 20 against the body 40 to allow material of the body 40 to flow into or enter the material-storing space 24 so as to fix the fitting portion 21 to the body 40. The threaded body 32 is movably disposed at the corpus portion 20. The two gears 30 are adapted to come into contact with two dentate structures 100 such that the two gears 30 and the dentate structures 100 in contact with the two gears 30 undergo movement, relative motion or motion. The motion of the gear 30 and the dentate structures 100 causes the motion of the post 31. Alternatively, the post 31 undergoes motion to drive the gear 30 and the dentate structures 100 undergoing motion. The threaded body 32 comes into contact with another dentate structure 200 such that the threaded body 32 and the dentate structure 200 undergo movement, relative motion or motion. The dentate structures 100, 200 can be racks, gears or threaded bodies. Therefore, the dentate structure 10 of the disclosure demonstrates excellence in practical operation.

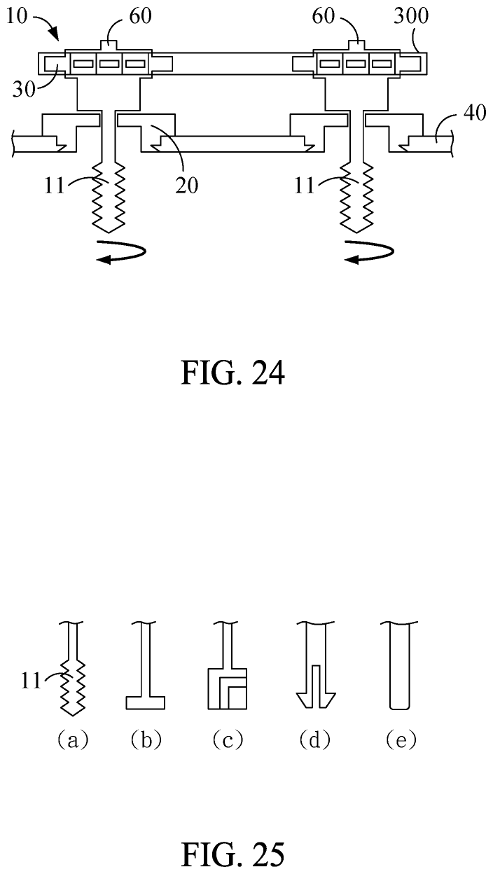

As shown in FIGS. 23, 24 and 25, the dentate structure 10 is in the number of two or more in the thirteenth embodiment of the disclosure and is in the number of three as shown in FIG. 23 for exemplary purposes. The first dentate portions (gears 30) of the three dentate structures 10 are connected by a connection component 300 and adapted to be driven, moved, jointly moved or linked. The connection component 300 is a link, track, strip-shaped piece, belt, metallic band, non-metallic band, dentate body, or chain. As shown in FIG. 24, the dentate structure 10 has an engaging portion 11 adapted to be driven, moved, jointly moved or linked. Alternatively, the engaging portion 11 is for use in fastening or for being fastened to another body (not shown in the diagram). As shown in FIG. 25, the engaging portion 11 is a threaded body (part a in FIG. 25), outer fastener (part b in FIG. 25), inner fastener (part c in FIG. 25), resilient fastener (part d in FIG. 25), or post (part e in FIG. 25). As shown in FIG. 23, each dentate structure 10 has a manipulating portion 90 for controllably operating or moving the engaging portion 11, and the manipulating portion 90 is cruciform in shape, rectangular in shape or square in shape. Therefore, the dentate structure 10 of the disclosure demonstrates excellence in practical operation.

Referring to FIG. 1 through FIG. 25, the second aspect of the disclosure provides a dentate structure 10 comprising a corpus portion 20 and a first dentate portion. The first dentate portion is exemplified by the gear 30. The gear 30 is coupled to the corpus portion 20; for example, the gear 30 is rotatably coupled to the corpus portion 20. The fitting portion 21 of the corpus portion 20 is adapted to be fitted to a body 40. The embodiments of the dentate structure 10 are the same as the embodiments of the dentate structure 10 involving the method and thus are, for the sake of brevity, not reiterated.

The disclosure is disclosed above by preferred embodiments. However, persons skilled in the art should understand that the embodiments are illustrative of the disclosure only, but shall not be interpreted as restrictive of the scope of the disclosure. Hence, all equivalent modifications and replacements made to the aforesaid embodiments shall be deemed falling within the scope of the claims of the disclosure. Accordingly, the legal protection for the disclosure shall be defined by the appended claims.

What is claimed is:

1. A method of using a dentate structure, the dentate structure comprising a corpus portion and a first dentate portion, the method comprising a step of coupling the first dentate portion to the corpus portion to allow a fitting portion of the corpus portion to be adapted to be fitted to a body.

2. The method of claim 1, wherein the fitting portion of the corpus portion has a material-storing space, and the method comprises a step of pressing the corpus portion against the body to allow material of the body to flow into or enter the material-storing space so as to fix the fitting portion to the body, or the fitting portion is an expanded connection structure, the body has a fitting hole, and the method comprises a step of placing the fitting portion at the fitting hole and pressing the fitting portion against the body to allow the dentate structure to be fixed to the body by the fitting portion through expanded connection, or the fitting portion is a solderable member, the body has a fitting hole, and the method comprises a step of placing the fitting portion at the fitting hole and heating up solder applied to the fitting portion to fix the corpus portion to the body by soldering, or the fitting portion comprises a fastening member, and the method comprises a step of fastening the fastening member to the fitting portion so as for the fastening member to be fixedly coupled to the body, or the fitting portion comprises an engaging member, and the method comprises a step of providing the engaging member engaged with the fitting portion and thus fixedly coupled to the body, or the fitting portion comprises a resilient engaging member, and the method comprises a step of providing the resilient engaging member engaged with the fitting portion and thus fixedly coupled to the body.

3. The method of claim 1, wherein the dentate structure comprises an intervening member conducive to friction reduction, and the method comprises a step of mounting the intervening member in place between the corpus portion and the first dentate portion.

4. The method of claim 1, wherein the corpus portion has a rotation-preventing portion, and the method comprises a step of providing the rotation-preventing portion conducive to rotation prevention and position limitation between the dentate structure and the body, or the method comprises a step of providing the rotation-preventing portion for limiting a binding position or direction of the dentate structure relative to the body, or the method comprises a step of providing the rotation-preventing portion for limiting a motion direction of the first dentate portion.

5. The method of claim 1, wherein the corpus portion has an axle portion and a head portion coupled to or integrally formed with the axle portion, with the first dentate portion restrained by the head portion and thus movably coupled to the axle portion, or the corpus portion has the axle portion fixedly coupled to the first dentate portion, the axle portion having a limiting portion outside the first dentate portion, allowing the axle portion and the limiting portion to be coupled to each other or integrally formed, and a seat portion is movably coupled to the axle portion and confined to between the first dentate portion and the limiting portion, or the corpus portion has a bolt portion adapted to be movably coupled to the first dentate portion, wherein the fitting portion and the corpus portion are coupled to each other or integrally formed.

6. The method of claim 1, wherein the dentate structure further comprises an operating member with a second dentate portion adapted to be actuated and thus motion-linked to the first dentate portion, or the second dentate portion moves in a pushing direction to come into contact with the first dentate portion and thus enable linked motion, the linked motion being movement, rotation, relative motion, labor-saving motion, gear motion, rack motion or linear motion, or the dentate structure comprises a manipulating portion extended to a side of the first dentate portion, or the method comprises a step of actuating the manipulating portion to allow the first dentate portion to rotate or allow the first dentate portion to be motion-linked to the second dentate portion to enable movement of the operating member, or the method comprises a step of operating the operating member so as for the second dentate portion to be actuated and thus motion-linked to the first dentate portion, so as to actuate the manipulating portion through rotation of the first dentate portion.

7. The method of claim 6, wherein the operating member has a second corpus portion with a second fitting portion adapted to be fitted to a second body, the second fitting portion having a second material-storing space, and the method comprises a step of pressing the second corpus portion against the second body to allow material of the second body to flow into or enter the second material-storing space to fix the second fitting portion to the second body, or the second fitting portion is an expanded connection structure, the second body having a second fitting hole, and the method comprises a step of placing the second fitting portion at the second fitting hole and pressing the second fitting portion against the second body to allow the operating member to be fixed to the second body by the second fitting portion through expanded connection, or the second fitting portion is a solderable member, the second body having a second fitting hole, and the method comprises a step of heating up solder applied to the second fitting portion to fix the second corpus portion to the second body by soldering.

8. The method of claim 6, wherein the operating member has a second corpus portion, or the second corpus portion has a position-limiting portion, or a second body fitted to the second corpus portion has a position-limiting portion, or the method comprises a step of providing the position-limiting portion conducive to rotation prevention, positioning or orienting between the corpus portion and the second body, or the operating member has an abutting portion or a second head portion such that the abutting portion or the second head portion abuts against the second corpus portion while the operating member is moving, or the operating member comprises a resilient component, and the method comprises a step of providing the resilient component with an end abutting against the second corpus portion and another end abutting against the abutting portion to allow the operating member to be normally pushed in a direction toward the second dentate portion, or providing the resilient component with an end abutting against the second corpus portion and another end abutting against the second head portion to allow the operating member to be normally pushed in a direction away from the second dentate portion.

9. The method of claim 6, wherein the operating member has a second corpus portion and is bolted to a second head portion, and the method comprises a step of providing the second head portion movable relative to the second corpus portion to an abutting high-position or an abutting low-position to abut against the second corpus portion, or attain positioning upon movement of the operating member, or resist a resilience force of a resilient component to attain positioning upon movement of the operating member, or the second corpus portion or the operating member has a second limiting portion, and the method comprises a step of providing the second limiting portion conducive to rotation prevention, positioning or orienting between the operating member and the second corpus portion.

10. The method of claim 1, wherein the body has teeth, and the method comprises a step of allowing the teeth to come into contact with the dentate structure so as for the dentate structure to drive the body undergoing movement, relative motion or motion, or the method comprises a step of allowing the dentate structure to come into contact with the teeth so as for the dentate structure in contact with a second dentate portion to undergo motion and thus drive the body undergoing movement, relative motion, motion, rotation or labor-saving motion.

11. The method of claim 1, wherein the dentate structure has two said first dentate portions, one of which undergoes motion together with or comes into contact with a dentate structure, or the two dentate portions undergo motion together with or come into contact with two dentate structures.

12. The method of claim 1, wherein the dentate structure comprises an operating member, or the first dentate portion is disposed at the body through the corpus portion, or the method comprises a step of configuring the first dentate portion as teeth in contact with a second body, or the first dentate portion comes into contact with a second dentate portion of the operating member, or a circuit is connected between the first dentate portion, the operating member or the second body, or the circuit is in communication connection with an electronic apparatus via wireless or wired signals, or is adapted to move the operating member to enable the first dentate portion, the operating member or the second body to transmit motion so as to control the electronic apparatus, or use the electronic apparatus to, via the signals, controllably cause the first dentate portion to rotate, or controllably cause the operating member to move, or drive the second body undergoing movement, relative motion or motion; or the body has a fixing element, or the fixing element comprises a head portion and a neck portion, or the operating member is movably disposed at the neck portion, or the operating member is restrained by the head portion.

13. The method of claim 1, wherein the dentate structure comprises two said first dentate portions, or one of the two first dentate portions is a threaded body, or the first dentate portion is adapted to come into contact with the dentate structure to allow the first dentate portion and the dentate structure in contact with the first dentate portion to undergo movement, relative motion or motion, or the first dentate portion has a post whose motion is caused by the motion of the first dentate portion and another dentate structure, or the post undergoes motion to drive the first dentate portion and another dentate structure undergoing motion, or the first dentate portions of at least two said dentate structures are connected by a connection component and adapted to be driven, moved, jointly moved or linked, or the dentate structure has an engaging portion adapted to be driven, moved, jointly moved or linked; or the engaging portion is for use in fastening or for being fastened to another body; or the dentate structure has a manipulating portion for controllably operating or moving the engaging portion.
